(19) United States
(12) Patent Application Publication
(10) Pub. No.: US 2004/0142237 A1
(43) Pub. Date: Jul. 22, 2004

(54) Alkaline storage battery and method

(76) Inventor: Gota Asano, Kanagawa (JP)

Correspondence Address: RATNERPRESTIA, P O BOX 980, VALLEY FORGE, PA, 19482-0980, US

(21) Appl. No.: 10/715,744

(22) Filed: Nov. 18, 2003

(30) Foreign Application Priority Data
Nov. 21, 2002 (JP) 2002-337699

(51) Int. Cl. H01M 2/26; H01M 2/12

(52) U.S. Cl. 429/161; 429/94; 429/178; 429/223; 429/53; 429/218.2

(57) ABSTRACT

An electrode group fabricated by spirally winding a positive plate and a negative plate with a separator interposed between them is housed in a metal case. An upper opening of the metal case is hermetically sealed with a gasket. One side edge along the longitudinal direction of the negative plate projects out downward of the electrode plate and is joined to the bottom of the metal case while the side edge along the longitudinal direction of the positive plate projects out upward of the electrode group and is joined to the lower surface of a sealing plate. A metal current collector having a cap-shaped terminal for joining the positive electrode side and the lower surface of the sealing plate and for collecting current is welded to the protrusion of the positive plate, and the metal current collector having a cap-shaped terminal is provided with a gas venting mechanism.

### FIELD OF THE INVENTION

The present invention relates to alkaline storage batteries and a method of manufacturing them, in particular, to high-output alkaline storage batteries that are high in capacity and that enable reduction in price, and a method for manufacturing the batteries.

### BACKGROUND OF THE INVENTION

In recent years, with the rapid progress in portable and cordless designs of devices, there is an increasing demand for lightweight and high-energy secondary batteries as the power source for these devices. The market requires secondary batteries that are especially high in capacity and low in price. Accordingly, there is a strong demand for price reduction and improvement of market reliability of alkaline storage batteries as represented by nickel-hydrogen storage batteries and nickel-cadmium storage batteries. More recently, there is an increasingly stronger demand for higher performance design of alkaline storage batteries for such high-power applications as digital still cameras, power tools, and even electric vehicles.

FIG. 4 illustrates the structure of a conventional alkaline storage battery. FIG. 4(a) is a longitudinal sectional view of a conventional alkaline storage battery as taken along a plane that passes the center of the positive terminal. FIG. 4(b) is a cross-sectional view as taken along the line B-B′ in FIG. 4(a). In FIG. 4, belt-like positive plate 3 and belt-like negative plate 4 are sandwiched by belt-like separator 5 that interposes between them for electrical insulation and spirally wound. After winding, the outer surface is fixed with a polypropylene tape or with extended separator 5 thus forming electrode group 22 (as disclosed, for example, in Japanese Patent Laid-Open Application No. 2000-285956). Negative plate 4 of electrode group 22 is welded with a copper welding rod and joined to circular bottom metal current collector 7, being a current collector for the negative electrode, through protrusion 16 that projects out downward of negative plate 4. After housing in metal case 6 electrode group 22 that has been welded and joined to bottom metal current collector 7, bottom metal current collector 7 welded at protrusion 16 of negative plate 4 and the bottom of metal case 6 are electrically joined with a copper welding rod by inserting a copper welding rod into a hollow space left by removing a mandrel from electrode group 22 that has been wound. Subsequently, protrusion 15 of positive plate 3, one side edge along the longitudinal direction of which being projecting out upward, is joined to the bottom surface of circular upper metal current collector 18. Lead 11, being a current collecting tub, is welded to an upper part of upper metal current collector 18 of the positive electrode side, and a predetermined quantity of an alkaline electrolyte is poured through an upper opening of metal case 6. Subsequently, metal sealing plate 17 provided with cap-shaped positive terminal 13 is inserted through the upper opening of metal case 6, and lead 11, being a current collecting tub, and the lower surface of metal sealing plate 17 are joined. Lastly, the upper opening of metal case 6 and the periphery of metal sealing place 17 are hermetically sealed through gasket 9 thus completing an alkaline storage battery.

However, in the above-described conventional structure of an alkaline storage battery, an extra space on the upper part of metal case 6 has been required as positive plate 3 and upper metal current collector 18, and negative plate 4 and bottom metal current collector 7, are to be respectively joined, and upper metal current collector 18 and metal sealing plate 17 provided with cap-shaped positive terminal 13 are to be joined to lead 11, being a relaying current collecting tub. Also, as lead 11, being a current collecting tub, is formed by folding a metal plate, an additional extra space has been needed. In other words, a space required for lead 11, being a relaying current collecting tub, is made available at the expense of the volume for the electrode group that can otherwise be utilized. This has been an obstacle against increase in the battery capacity and an issue to be solved.

Also, as the above-described conventional alkaline storage battery comprises upper metal current collector 18 to be joined to the upper side edge in the longitudinal direction of positive plate 3, and lead 11, being a relaying current collecting tub, that joins upper metal current collector 18 and the lower part of metal sealing plate 17, a certain number of components and related processes of joining them are inevitable thus leading to an increase in the manufacturing cost and in the number of manufacturing man-hours. Accordingly, attainment of a further higher capacity and price reduction of alkaline storage batteries has been an issue left to be solved.

### SUMMARY OF THE INVENTION

The present invention addresses the above issues. It is an object of the present invention to provide a high-output and high-capacity alkaline storage battery by utilizing the space occupied by a lead, being a current collecting tub made of a metal, that has been required in a conventional alkaline storage battery for joining an upper metal current collector and the lower part of a metal sealing plate for increasing the volume of the electrode group that can be used for the battery and to provide a method for manufacturing an alkaline storage battery in which manufacturing cost and manufacturing man-hours are reduced by decreasing the number of components that have heretofore been required.

In order to achieve the above object, the alkaline storage battery of the present invention comprises a cylindrical metal case one end of which being circular and closed and the other end being open, a positive plate one side edge along the longitudinal direction of which having a protrusion that projects out, a negative plate one side edge along the longitudinal direction of which having a protrusion that projects out, an insulating separator, an upper metal current collector for collecting current for the positive electrode side and provided with a cap-shaped terminal, a bottom metal current collector for collecting current for the negative electrode side, and a metal sealing plate having a hole formed in the center. The alkaline storage battery is constructed in a manner such that an electrode group is formed by spirally winding the positive plate and the negative plate with the separator interposed between them and with the protrusions of the positive plate and the negative plate facing mutually opposite directions, the protrusion of the negative plate is joined to the bottom metal current collector, followed by housing the electrode group into the metal case, joining the bottom metal current collector and the bottom of the metal case, joining the protrusion of the positive plate to the bottom surface of the upper metal current collector, disposing the cap-shaped terminal of the upper metal current collector through the central hole of the metal sealing plate, joining the upper metal current collector and the metal sealing plate, pouring a predetermined quantity of an electrolyte from above the electrode group, and hermetically sealing the periphery of the sealing plate with a gasket at the upper opening of the metal case. Also, in a structure of the alkaline storage battery of the present invention, the positive plate contains a nickel compound and the negative plate contains a hydrogen absorbing alloy, and the electrolyte is an alkaline electrolyte. Also, in addition to a structure of the alkaline storage battery of the present invention in which a gas venting mechanism is provided in the metal current collector having a cap-shaped terminal, it also has a structure in which an elastic vent member is provided inside the terminal of the metal current collector having a terminal. The gas venting mechanism that the metal current collector having a cap-shaped terminal has is structured in a manner such that incisions are provided from the periphery toward the center in two to four directions and an elastic vent member is provided inside the terminal. Also, with the alkaline storage battery of the present invention, the metal sealing plate is annular in shape having a hole in the center with a size equal to or greater than the size of the cap-shaped terminal of the upper metal current collector in a manner such that the cap-shaped terminal of the upper metal current collector can pass through the hole to become a terminal for the positive electrode side. Also, in the structure of the alkaline storage battery of the present invention, asphalt is coated in the gap between the upper metal current collector and the annular metal sealing plate when joining the upper metal current collector and the metal sealing plate. Also, the alkaline storage battery of the present invention is so structured that the diameter of the cap-shaped terminal of the metal current collector having a cap-shaped terminal is in the range ⅕ to ⅘ of the outer diameter of the metal case.

As the upper part of the positive plate and the sealing plate are directly joined, the adoption of these structures enables significant reduction in resistance when compared with conventional current collection by means of a relaying lead. Also, while a conventional relaying lead for joining the upper part of the positive plate and the lower part of the sealing plate occupied a space of 3 mm or more in height, such extra space can be effectively utilized as a volume for the electrode plates thus providing a high-capacity and high-output alkaline storage battery.

Also, the method for manufacturing an alkaline storage battery of the present invention comprises:

a step of disposing a positive plate having a protrusion that projects out from one side edge along the longitudinal direction and a negative plate having a protrusion that projects out from one side edge along the longitudinal direction in a manner such that the protrusion of the positive plate and the protrusion of the negative plate face mutually opposite directions, forming an electrode group by spirally winding the positive plate and the negative plate with an insulating separator interposed between them, and fixing the electrode group by winding its outer surface with a tape;

a step of housing the electrode group of which the protrusion of the negative plate and the bottom metal current collector for collecting the negative electrode side have been joined into a cylindrical metal case one end of which being disc-shaped and closed and the other end being open;

a step of joining the bottom metal current collector that has been joined to the protrusion of the negative plate of the electrode group and the bottom of the metal case;

a step of joining the protrusion of the positive plate of the electrode group and the upper metal current collector having a cap-shaped terminal for collecting current for the positive electrode side;

a step of disposing the cap-shaped terminal of the upper metal current collector, to which the protrusion of the positive plate has been joined, through a holed metal sealing plate and joining from above;

a step of pouring a predetermined quantity of an electrolyte from above the electrode group; and

a step of hermetically sealing the periphery of the metal sealing plate with a gasket at the upper opening of the metal case. Also, the method for manufacturing an alkaline storage battery of the present invention includes a step of inserting a welding rod through a hollow space in the center of the electrode group left by removing a mandrel after winding the electrode group and joining the bottom metal current collector that has been welded to the protrusion of the negative plate and the bottom of the metal case.

By including these steps, as the electrode group to which the metal current collector having a cap-shaped terminal has been welded and the sealing plate having a hole in the center into which the terminal portion has been inserted with a gasket put in a gap are welded from above, the manufacturing steps of joining the upper metal current collector and the relaying lead, joining of the sealing plate, the positive plate, and the upper metal current collector, and bending of the lead are not required. Accordingly, the only step that is necessary is that of insertion of the upper terminal side of the positive electrode thus enabling simplification of the conventional battery manufacturing process and realization of a low cost alkaline storage battery.

### BRIEF DESCRIPTION OF THE DRAWINGS

FIG. 1(a) is a longitudinal sectional view showing the structure of an example of an alkaline storage battery as taken along a plane that passes through the center of the positive terminal in a preferred embodiment of the present invention.

FIG. 1(b) is a cross-sectional view as taken along the line A-A′ in FIG. 1(a).

FIG. 2 is an exploded schematic diagram to illustrate the sealing plate welding step of an alkaline storage battery in the preferred embodiment of the present invention.

FIG. 3 is a diagram to illustrate the assembling process of a metal current collector having a cap-shaped terminal that also serves as a gas venting mechanism of an alkaline storage battery in the preferred embodiment of the present invention.

FIG. 4(a) is a longitudinal sectional view showing the structure of a conventional alkaline storage battery as taken along a plane that passes the center of the positive terminal.

FIG. 4(b) is a cross-sectional view as taken along the line B-B′ in FIG. 4(a).

### DETAILED DESCRIPTION OF THE INVENTION

A detailed description of the alkaline storage battery and method for manufacturing it in the present invention will be given in the following with referring to drawings.

### PREFERRED EMBODIMENT

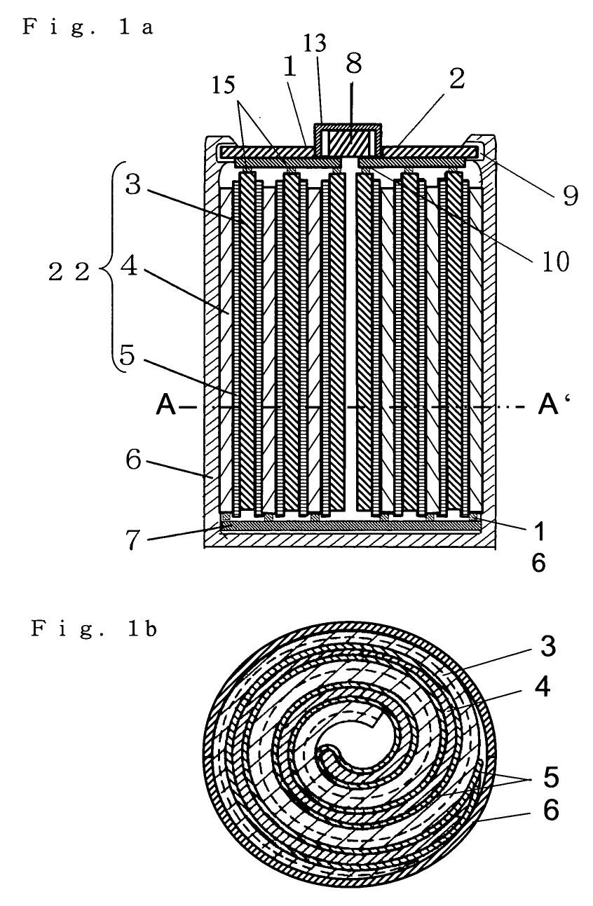

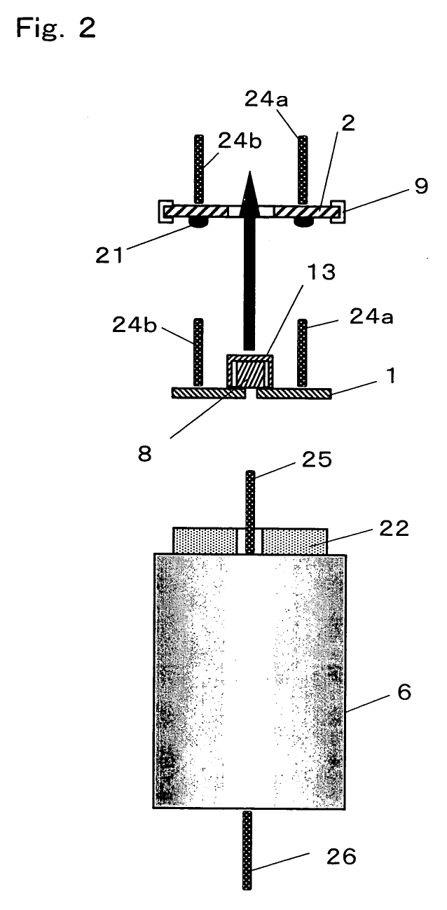

FIG. 1 illustrates an example of the structure of an alkaline storage battery in a preferred embodiment of the present invention. FIG. 1(a) is a longitudinal cross-sectional view of the alkaline storage battery in the preferred embodiment of the present invention as taken along a plane that passes the center of the positive terminal. FIG. 1(b) is a cross-sectional view of the alkaline storage battery as taken along the line A-A′ in FIG. 1(a). FIG. 2 is an exploded schematic diagram to illustrate the welding step of a sealing plate of the alkaline storage battery in the preferred embodiment of the present invention.

In FIG. 1, electrode group 22 is fabricated by spirally winding belt-like positive plate 3 and belt-like negative plate 4 with belt-like separator 5 interposed between them for electric insulation followed by fixing the outer surface with a polypropylene tape or separator 5 that has been extended. With electrode group 22, protrusion 16 of negative plate 4 that projects out downward of negative 4 is welded with a copper welding rod and joined to circular bottom metal current collector 7, being a current collector for the negative electrode. After housing electrode group 22 that has been welded and joined to bottom metal current collector 7 into metal case 6, copper welding rod 25 is inserted into a hole left by removing a mandrel after winding electrode group 22, and bottom metal current collector 7 welded at protrusion 16 of negative plate 4 and the bottom of metal case 6 are welded and electrically joined.

Subsequently, copper welding rod 25 is drawn out, and protrusion 15 of positive plate 3, one end along the longitudinal direction of which being projecting out upward of electrode group 22, is welded and joined to the bottom surface of metal current collector 1 having a cap-shaped terminal with lower welding rod 26 and upper welding rods 24a, 24b. A predetermined quantity of an alkaline electrolyte is then poured from an upper opening of metal case 6, doughnut-like sealing plate 2 made of a metal and provided with a hole for passing cap-shaped positive terminal 13 is inserted from the upper opening of metal case 6, positive terminal 13 is inserted into the hole of doughnut-like sealing plate 2 as shown by the thick arrow in FIG. 2, and the positive electrode side and the lower surface of doughnut-like sealing plate 2 are welded and joined with lower welding rod 26 and upper welding rods 24a, 24b.

Lastly, the upper opening of metal case 6 and the periphery of doughnut-like sealing plate 2 are hermetically sealed with gasket 9 thus completing an alkaline storage battery of the preferred embodiment of the present invention. Here, pouring of the electrolyte is performed by once storing the electrolyte on the upper part of electrode group 22 and then allowing it to penetrate into the gap between the electrode group and the case with the help of a vacuum. Also, the diameter of the cap-shaped terminal that serves as positive terminal 13 of the metal current collector having a cap-shaped terminal is preferably in the range ⅕ to ⅘ of the outer diameter of the battery. Furthermore, in the manufacturing process of an alkaline storage battery in the preferred embodiment of the present invention as described above, if asphalt 21 is coated on the lower surface of doughnut-like sealing plate 2 as illustrated in FIG. 2, the lower surface of doughnut-like sealing plate 2 closely adheres to metal current collector 1 having a terminal and airtightness can be improved.

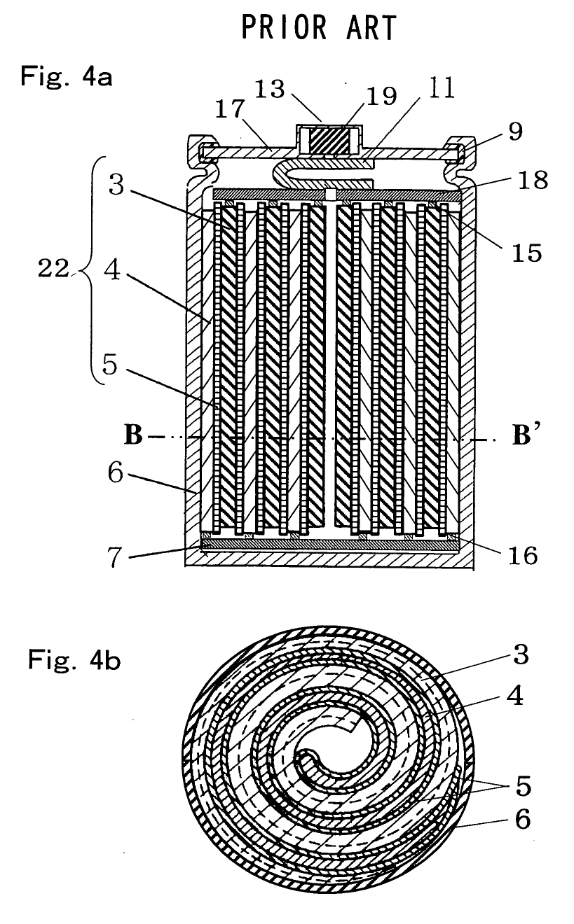

As has been described above, a two-step welding process is employed in which bottom metal current collector 7 is first welded to the lower part of the negative electrode of electrode group 22 and then electrode group 22 and case 6 are welded through bottom metal current collector 7. Resistance welding system using an inverter power supply is employed for the welding. Since electrode group 22 which has been spirally wound will become loose unless it is fixed, the upper part is welded as part of a continuous manufacturing process after fixing electrode group 22 by inserting into metal case 6. Also, metal current collector 1 having a cap-shaped terminal is provided with a gas venting mechanism to be described later. By the way, the difference of the structure of the alkaline storage battery of the preferred embodiment of the present invention from that of the afore-described conventional alkaline storage battery as shown in FIG. 4 lies in that the former does not have lead 11, being a relaying current collector, and that upper metal current collector 18 and sealing plate 17 are replaced with metal current collector 1 having a cap-shaped terminal and doughnut-like sealing plate 2, respectively. Other structures are almost the same as those of the conventional alkaline storage battery. Accordingly, those structural elements that are similar to those of the conventional alkaline storage battery have the same reference numerals.

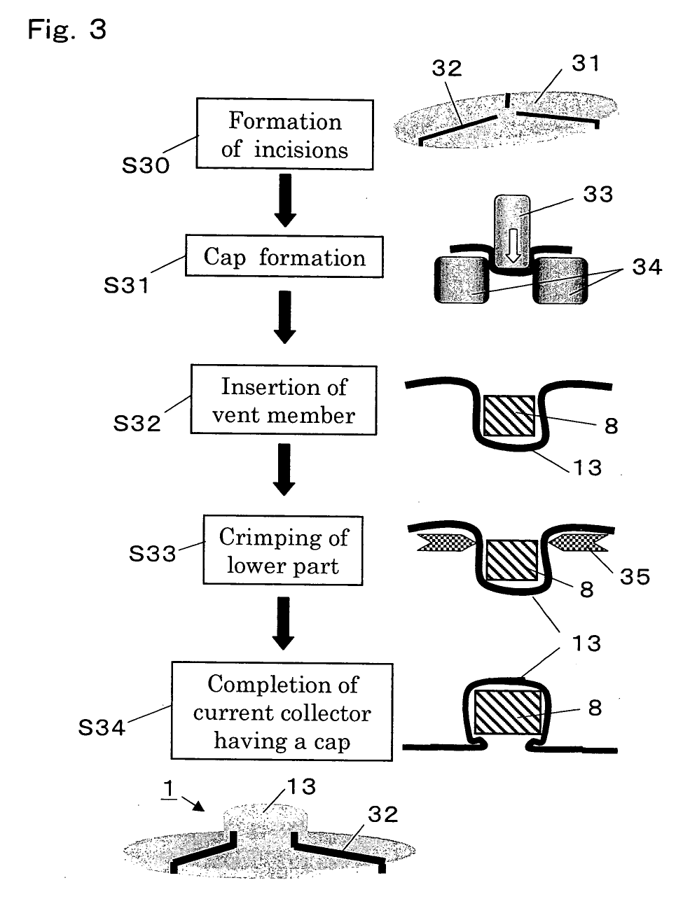

Next, a description will be given on the steps of forming metal current collector 1 having a cap-shaped terminal that is equipped with a gas venting mechanism. FIG. 3 is a diagram to illustrate the steps of assembling metal current collector 1 having a cap-shaped terminal that concurrently serves as a gas venting mechanism of the alkaline storage battery of the preferred embodiment of the present invention. In FIG. 3, metal current collector 1 having a cap-shaped terminal is formed by placing on die 34 the central portion of metal disc 31 on which incisions 32 have been made in two to four directions and punching with punch 33 to make cap portion 13 (Step 31). Subsequently, rubber vent member 8 having resiliency is inserted into a hole of positive terminal 13, being a cap-shaped terminal, formed at the center of metal disc 31 (Step 32), an opening below the current collector is crimped with crimping jig 35 from the lower periphery of positive terminal 13 (Step 33), and rubber vent member 8 having resiliency is sealed in and secured (Step 34). As gas vent section 19 that is formed on sealing plate 17 using a cap, a filter, etc., in the manufacture of a conventional alkaline storage battery is replaced with the above-mentioned incisions 32 of the current collector, by securing rubber vent member 8 having resiliency by crimping, the cap, filer, etc., that have been needed with the conventional sealing plate are made unnecessary as are the associated man-hours.

A description of a practical example of the alkaline storage battery in the preferred embodiment of the present invention will be given in the following.

### EXEMPLARY EMBODIMENT

To begin with, an active material for an alkaline storage battery was prepared. Paste of an active material was prepared by adding 0.2 part by weight of carboxymethyl cellulose as a binder and water to 100 parts by weight of nickel hydroxide and kneading. Here, the amount of water to be added was chosen to be 25 wt % of the total paste weight.

Belt-like positive plate 3, 48.2 mm wide, 0.7 mm thick, 113 mm long, was fabricated by charging a foamed nickel substrate with the active material paste, drying, and pressing to increase the charging density, and forming by ultrasonic peeling an area free of the active material, 1.5 mm in width, on the upper part in the longitudinal direction.

Subsequently, belt-like negative plate 4, 48.2 mm wide, 0.3 mm thick, 204 mm long, was fabricated by coating powder of hydrogen absorbing alloy on a core material made of a punching metal leaving an uncoated portion of 2 mm width in the lower part in the longitudinal direction, and nickel plating the surface. By nickel plating the surface of negative plate 4, water repellency can be provided to the surface of the negative electrode. As an added effect, a greater conductivity can be given to the surface of the negative electrode alloy thus providing advantages of easy handling in the manufacturing process of the alkaline storage battery as well as improved battery performance.

Electrode group 22 was fabricated by sandwiching the above-described belt-like positive plate 3 and belt-like negative plate 4 with belt-like separator 5 that interposes between them for electric insulation. After spirally winding electrode group 22 around a mandrel with a 3.5 mm diameter, electrode group 22 was fixed by winding around it two turns of a 0.1 mm thick polypropylene tape, and circular bottom metal current collector 7 was resistance welded with a copper welding rode to protrusion 16 on the lower part of negative plate 4. After inserting into metal case 6 electrode group 22 to which bottom metal current collector 7 had been welded and joined, upper protrusion 15 of positive plate 3 and metal current collector 1 having a cap-shaped terminal were welded, bottom metal current collector 7 welded to protrusion 16 on the lower part of negative plate 4 and the bottom of metal case 6 were electrically joined by inserting a copper welding rod through a hollow space left by removing the mandrel from electrode group 22. Subsequently, after inserting gasket 9 that also serves as an insulating ring, terminal section 8 of current collector 1 having a cap-shaped terminal was inserted into a hole provided in the center of doughnut-like sealing plate 2 and was welded with current collector 1 having a cap-shaped terminal from above doughnut-like sealing plate 2. Lastly, an alkaline electrolyte was poured, the assembly was hermetically sealed with gasket 9 put on doughnut-like sealing plate 2, and nickel-hydrogen storage battery “A”, being an AA-size alkaline storage battery having a structure illustrated in FIG. 1 of the preferred embodiment of the present invention, was completed.

### CONTROL EXAMPLE

Next, an alkaline storage battery of a conventional structure was fabricated in order to compare with the alkaline storage battery in the preferred embodiment of the present invention. A description of its practical structure and the manufacturing process is given below.

As the active material for the alkaline storage battery of a conventional structure fabricated for comparison, exactly the same active material as used in the above-described exemplary embodiment was used: that is, active material paste was prepared by adding 0.2 part by weight of carboxymethyl cellulose as the binder and water amounting to 25 wt % of the total paste to 100 parts by weight of nickel hydroxide and kneading.

Belt-like positive plate 3, 43.7 mm wide, 0.7 mm thick, 113 mm long, was fabricated by charging a foamed nickel substrate with the active material paste prepared by the same steps as in fabricating the alkaline storage battery of the exemplary embodiment and drying, pressing to increase the charging density, and forming by ultrasonic peeling an area free of the active material of 1.5 mm width on the upper part in the longitudinal direction. The structure of the control example is exactly the same as that of the exemplary embodiment.

Subsequently, belt-like negative plate, 43.7 mm wide, 0.3 mm thick, 204 mm long, was fabricated by coating hydrogen absorbing alloy powder on a core material made of a punching metal leaving an uncoated portion of 2 mm width on the lower part in the longitudinal direction. The width in the direction of the height of negative plate 4 of the control example is shorter by 4.5 mm than that of negative plate 4 of the exemplary embodiment.

Similarly, electrode group 22 was fabricated by sandwiching belt-like positive plate 3 and belt-like negative plate 4 with belt-like separator 5 that interposes between them for electrical insulation and spirally winding around a mandrel having a diameter of 3.5 mm. The electrode group 22 was then fixed by winding two turns of a polypropylene tape around it, and circular bottom metal current collector 7 was resistance welded with a copper welding rod to protrusion 16 on the lower part of negative plate 4. After inserting into metal case 6 electrode group 22 to which bottom metal current collector had been welded and joined, upper protrusion 15 of positive plate 3 and the bottom surface of upper metal current collector 18 to which lead 11, being a relaying tub, had been joined were welded, circular bottom metal current collector 7 that had been welded to protrusion 16 of the lower part of negative plate 4 and the bottom of metal case 6 were electrically joined by inserting a copper welding rod through a hollow space of electrode group 22 left by removing the mandrel. After pouring an alkaline electrolyte, the upper part of the open end of battery case 6 is hermetically sealed with sealing plate 17 that also serves as positive terminal 13, and nickel-hydrogen storage battery “B”, being an AA-size alkaline storage battery of a conventional structure as illustrated in FIG. 4, was completed.

Table 1 shows the results of measurement of various characteristics of battery “A” fabricated as an exemplary embodiment of the alkaline storage battery of the preferred embodiment of the present invention and battery “B” fabricated as a control example having a conventional structure.

TABLE 1
Measured results of alkaline storage batteries
of the present invention and of a conventional structure.

| | Exemplary | |
|---|---|---|
| | Embodiment | Control Example |
| | (Battery “A”) | (Battery “B”) |
| | Structure of the | Conventional |
| | present invention | structure |
| AC internal resistance | 4-5 mΩ | 7-9 mΩ |
| Battery capacity | 1700 mAh | 1500 mAh |
| Low-temperature | 80% | 70% |
| discharge | | |
| characteristic | | |

Table 1 shows that, while the measured result of AC internal resistance of battery “B” was 7 to 9 mΩ, that of battery “A” of the present invention was 4 to 5 mΩ indicating that the internal resistance has been greatly reduced and that the advantage of not using a relaying lead in the alkaline storage battery of the preferred embodiment of the present invention is great.

Additionally, the capacity of battery “A” and battery “B” was measured by first charging at a charging current of 1100 mA until −dV control is detected and discharging at a discharging current of 300 mA at 25° C. ambient until a final voltage of 1 V/cell is reached. While the capacity of battery “B” with the conventional structure was 1500 mAh, that of battery “A” of the present invention was 1700 mAh, meaning a high-output characteristic with an increase by about 15% and demonstrating that a higher capacity has been realized.

Also, characteristics were compared under the same charging condition but at a discharging current of 4 A at −10° C. ambient. It was found that while conventional battery “B” had a discharge rate of 70% at a discharging current of 300 mA at 25° C. ambient, battery “A” of the present invention could have been discharged to more than 80% exhibiting a superior characteristic in low-temperature discharge characteristic, too.

Accordingly, with the alkaline storage battery of the preferred embodiment of the present invention, as the metal current collector provided with a cap-shaped terminal for joining the positive electrode side and the lower part of the sealing plate and for collecting current is welded and joined to a protrusion of the positive electrode, a greatly lowered resistance could be realized compared with current collection through a conventional relaying lead. The relaying lead for joining the upper part of the positive plate and the lower part of the sealing plate heretofore required a space greater than 3 mm in height in a folded state. However, as the metal current collector having a cap-shaped terminal is provided with a gas venting mechanism, the un-used space can be effectively utilized as an extra volume for the electrode group of the battery thus providing a higher capacity.

In the method for manufacturing an alkaline storage battery of the present invention, too, as an electrode group to which a metal current collector having a cap-shaped terminal has been welded and a sealing plate having a hole in the center are welded from above after inserting the terminal portion into the sealing plate with a gasket put in a gap, it is not necessary to go through the manufacturing steps of joining the upper metal current collector and the relaying lead, joining the sealing plate, the positive plate and the upper current collector, bending the lead, etc. As the only step is the insertion of the terminal portion on the upper part of the positive plate, the battery manufacturing process can be simplified than the conventional process, reductions in the component count and the man-hours are enabled thus realizing a lower price.

As has been described above, the alkaline storage battery of the present invention can achieve an output that is higher than a battery of the conventional structure without use of the conventional current collecting scheme as well as a capacity that is higher by about 15%. Furthermore, as the manufacturing process can be simplified, it enables design of a low-cost, high-power alkaline storage battery.

What is claimed is:

1. An alkaline storage battery comprising:
a cylindrical metal case one end of which being circular and closed the other end being open;
a positive plate having a protrusion made by projecting out one side edge along the longitudinal direction of said positive electrode;
a negative plate having a protrusion made by projecting out one side edge along the longitudinal direction of said negative plate;
a separator having insulating properties;
an upper metal current collector for collecting current from a positive electrode side and having a cap-shaped terminal;
a bottom metal current collector for collecting current from a negative electrode side; and
a sealing plate made of a metal with a hole formed at the center;
wherein:
an electrode group is formed by spirally winding said positive plate and said negative plate with said separator interposed between them with said protrusion of said positive plate and said protrusion of said negative plate facing mutually opposite directions;
said electrode group is housed in said metal case after joining said protrusion of said negative plate with said bottom metal current collector, and said bottom metal current collector and the bottom of said metal case are joined;
said protrusion of said positive plate is joined with the bottom surface of said upper metal current collector;
said cap-shaped terminal of said upper metal current collector is disposed through a hole in the center of said sealing plate made of a metal, and said upper metal current collector and said sealing plate made of a metal are joined;
a predetermined quantity of an electrolyte is poured from above said electrode group; and
the periphery of said sealing plate is hermetically sealed with a gasket at the upper opening of said metal case.

2. The alkaline storage battery of claim 1 wherein said positive plate contains a nickel compound, said negative plate contains a hydrogen absorbing alloy, and said electrolyte is an alkaline electrolyte.

3. The alkaline storage battery of claim 1 wherein said metal current collector having said cap-shaped terminal is provided with a gas venting mechanism.

4. The alkaline storage battery of claim 1 wherein a resilient vent member is provided inside said terminal of said metal current collector having a terminal.

5. The alkaline storage battery of claim 3 wherein said gas venting mechanism of said metal current collector having said cap-shaped terminal includes incisions made in two to four directions from the periphery toward the center of said metal current collector and a resilient vent member located inside said terminal.

6. The alkaline storage battery of claim 1 wherein said sealing plate made of a metal is annular in shape having a hole in the center with a size at least equal to the size of said cap-shaped terminal of said upper metal current collector, and said cap-shaped terminal of said upper metal current collector passes through said hole to become a terminal for the positive electrode side.

7. The alkaline storage battery of claim 6 wherein asphalt is coated in a gap between said upper metal current collector and said annular sealing plate made of a metal when joining said upper metal current collector and said sealing plate made of a metal.

8. The alkaline storage battery of claim 1 wherein the diameter of said metal current collector having said cap-shaped terminal is in the range ⅕ to ⅘ of the outer diameter of said metal case.

9. A method for manufacturing an alkaline storage battery the method comprising the steps of:
forming an electrode group by disposing a positive plate having a protrusion made by projecting out one side edge along the longitudinal direction of said positive electrode and a negative plate having a protrusion made by projecting out one side edge along the longitudinal direction of said negative plate in a manner such that said protrusion of said positive plate and said protrusion of said negative plate face mutually opposite directions, and spirally winding said positive plate and said negative plate with an insulating separator interposed, and fixing said electrode group by winding outer periphery thereof with a tape;
housing said electrode group into a cylindrical metal case one end of which being circular and closed and the other end being open after joining said protrusion of said negative plate and a bottom metal current collector for collecting current for the negative electrode side;
joining said bottom metal current collector joined to said protrusion of said negative plate of said electrode group and the bottom of said metal case;
joining said protrusion of said positive plate of said electrode group and an upper metal current collector having a cap-shaped terminal for collecting current for the positive electrode side;
disposing said cap-shaped terminal of said upper metal current collector to which said protrusion of said positive plate has been joined through a sealing plate made of a metal having a hole and joining from above;
pouring a predetermined quantity of an electrolyte from above said electrode group; and
hermetically sealing the periphery of said sealing plate made of a metal with a gasket at the upper opening of said metal case.

10. The method for manufacturing an alkaline storage battery of claim 9 wherein, when joining said bottom metal current collector and the bottom of said metal case, said bottom metal current collector welded to said protrusion of said negative plate and the bottom of said metal case are joined by inserting a welding rod through a hollow space in the center of said electrode group left by removing a mandrel after said electrode group has been wound.
